(19) United States
(12) Patent Application Publication
(10) Pub. No.: US 2024/0248664 A1
(43) Pub. Date: Jul. 25, 2024

(54) ASSIST INFORMATION PROVIDING METHOD AND RECORDING MEDIUM

(71) Applicant: Panasonic Automotive Systems Co., Ltd., Kanagawa (JP)

(72) Inventors: Takuma IIDA, Kanagawa Ken (JP); Toru FUJISAWA, Okayama Ken (JP); Takuro KOYAMA, Kanagawa Ken (JP); Makoto HINATA, Kanagawa Ken (JP)

(73) Assignee: Panasonic Automotive Systems Co., Ltd., Kanagawa (JP)

(21) Appl. No.: 18/623,262

(22) Filed: Apr. 1, 2024

Related U.S. Application Data
(63) Continuation of application No. PCT/JP2022/035758, filed on Sep. 26, 2022.

(30) Foreign Application Priority Data
Oct. 12, 2021 (JP) 2021-167674

(51) Int. Cl. G06F 3/14; G06F 3/01; G06T 7/70; G06V 20/20; G06V 20/58

(52) U.S. Cl. CPC G06F 3/14; G06T 7/70; G06F 3/012; G06F 3/013; G06T 2207/30252; G06V 20/20; G06V 20/58

(57) ABSTRACT

An assist information providing method is implemented by an information processing device. The information processing device communicates with a display terminal. The display terminal displays an image on a user's field of view to provide assist information to be displayed on the display terminal. The method includes acquiring an image obtained by performing imaging in a moving direction of a user. The method includes detecting an object included in the image. The method includes determining a position of the object in the user's field of view as a superimposition position of assist information regarding the object. The method includes transmitting information about the superimposition position to the display terminal to cause the display terminal to superimpose and display the assist information on the user's field of view at timing corresponding to the superimposition position.

### CROSS-REFERENCE TO RELATED APPLICATIONS

This application is a continuation of International Application No. PCT/JP2022/035758, filed on Sep. 26, 2022 which claims the benefit of priority of the prior Japanese Patent Application No. 2021-167674, filed on Oct. 12, 2021, the entire contents of which are incorporated herein by reference.

### FIELD

The present disclosure relates to an assist information providing method and a recording medium.

### BACKGROUND

Conventionally, there has been known technology for calling attention by displaying assist information regarding a detected object such as a sign or a pedestrian to assist an action of the pedestrian or assist driving of a moving body such as a vehicle (for example, a patent literature JP 2012-014616 A).

Under such circumstances, for example, it is assumed that assist information for action assist or driving assist is superimposed and displayed on a field of view of a user such as a pedestrian or a driver of a moving body by using Cross Reality (XR) technology including Augmented Reality (AR).

However, human visual characteristics are not uniform in the field of view. For this reason, even if the assist information is superimposed and displayed on the field of view or a real image corresponding to the field of view, there is a case where visibility is low, such as difficulty in recognizing the assist information. In a case where the visibility of the assist information is low, it is not possible to appropriately call attention or provide information to the user, and there is a problem that the safety of the user cannot be improved.

### SUMMARY

An assist information providing method according to the present disclosure is implemented by an information processing device. The information processing device communicates with a display terminal. The display terminal displays an image on a user's field of view to provide assist information to be displayed on the display terminal. The method includes acquiring an image obtained by performing imaging in a moving direction of a user. The method includes detecting an object included in the image. The method includes determining a position of the object in the user's field of view as a superimposition position of assist information regarding the object. The method includes transmitting information about the superimposition position to the display terminal to cause the display terminal to superimpose and display the assist information on the user's field of view at timing corresponding to the superimposition position.

### BRIEF DESCRIPTION OF THE DRAWINGS

FIG. 1 is a block diagram illustrating an example of a configuration of an assist information display system according to a first embodiment;

FIG. 2 is a block diagram illustrating an example of a hardware configuration of each device included in the assist information display system according to the first embodiment;

FIG. 3 is a block diagram illustrating an example of a functional configuration of a display terminal according to the first embodiment;

FIG. 4 is a block diagram illustrating an example of a functional configuration of an information processing device according to the first embodiment;

FIG. 5 is a diagram illustrating a relation between a user's field of view and a superimposition position in superimposition display of assist information according to the first embodiment;

FIG. 6 is a diagram illustrating a relation between a superimposition position and display timing in superimposition display of assist information according to the first embodiment;

FIG. 7 is a sequence diagram illustrating an example of assist information display processing according to the first embodiment; and

FIG. 8 is a sequence diagram illustrating an example of assist information display processing according to a second embodiment.

### DETAILED DESCRIPTION

Hereinafter, embodiments of an assist information providing method, an assist information display program, and a recording medium according to the present disclosure will be described with reference to the drawings.

In the description of the present disclosure, components having the same or substantially the same functions as those described above with respect to the previous drawings may be denoted by the same reference numerals, and the description thereof may be appropriately omitted. Even in a case of representing the same or substantially the same portion, dimensions and ratios may be represented differently from each other depending on the drawings. From the viewpoint of securing the visibility of the drawings, in the description of each drawing, only main components may be denoted by reference numerals, and even components having the same or substantially the same functions as those described above in the previous drawings may not be denoted by reference numerals.

### First Embodiment

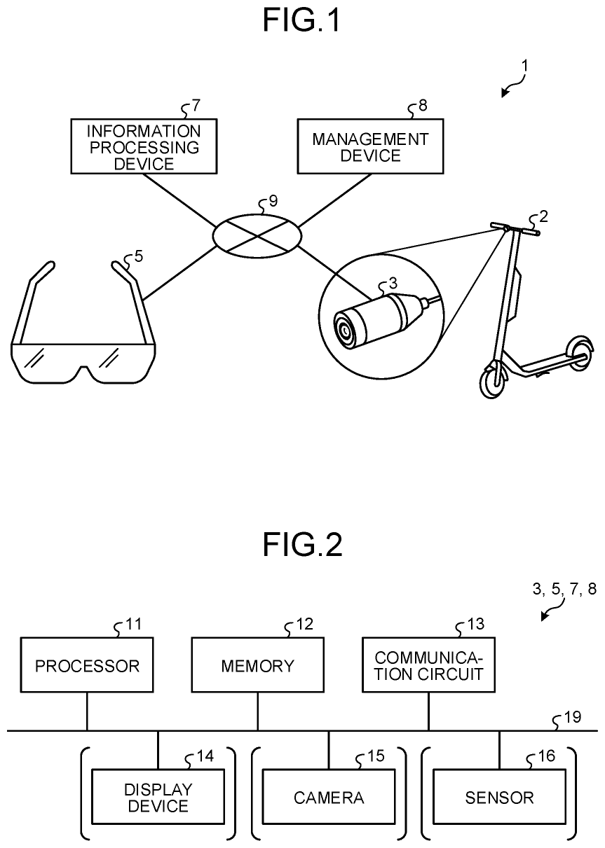

FIG. 1 is a block diagram illustrating an example of a configuration of an assist information display system 1 according to a first embodiment. The assist information display system 1 according to the embodiment is a system for displaying assist information regarding an object such as a sign or a pedestrian detected with respect to a field of view of a user such as the pedestrian, a driver of a moving body 2, and a passenger using Cross Reality (XR) technology.

As illustrated in FIG. 1, the assist information display system 1 includes a camera terminal 3, a display terminal 5, an information processing device 7, and a management device 8. The camera terminal 3, the display terminal 5, the information processing device 7, and the management device 8 are communicably connected via a network 9.

Note that, in the present embodiment, a case where the camera terminal 3 is connected to the network 9 via the display terminal 5 will be described as an example, but the camera terminal 3 may be directly connected to the network 9. In a case where the moving body 2 has a communication function, the camera terminal 3 may be connected to the network 9 via the moving body 2. As an example, the assist information display system 1 is constructed as a server-client type system including the information processing device 7 as a server device and the display terminal 5 as a client device.

The camera terminal 3 is mounted on the moving body 2, for example. The camera terminal 3 acquires an image obtained by imaging a traveling direction of the moving body 2. In other words, the camera terminal 3 acquires an image obtained by imaging a moving direction of the user. The camera terminal 3 outputs data of the acquired image to the information processing device 7 via the display terminal 5.

Note that, in the present embodiment, a case where the camera terminal 3 is mounted on the moving body 2 will be described as an example, but the present disclosure is not limited thereto. The camera terminal 3 may be mounted on, for example, the display terminal 5. Alternatively, the camera terminal 3 may be mounted on a head, a chest, or the like of the user separately from the display terminal 5.

Note that, in the present embodiment, a case where the user moves by the moving body 2 will be described as an example, but the present disclosure is not limited thereto. The user of the display terminal 5 may be a driver of the moving body 2, a passenger of the moving body 2, or a pedestrian who is not using the moving body 2. In other words, the assist information display system 1 according to the present embodiment may be a system that executes driving assist of the moving body 2 or a system that executes behavior assist of a pedestrian.

Note that FIG. 1 illustrates an electric scooter as an example of the moving body 2, but the present disclosure is not limited thereto. As the moving body 2, for example, various vehicles such as a wheelchair, a bicycle, an automobile, a motorcycle, and a railway vehicle can be appropriately used. In addition, the moving body 2 may be driven by any drive system. For example, the moving body 2 may be driven using a mounted battery, may be driven using an internal combustion engine, or may be driven by human power. Note that the technology according to the present disclosure is not limited to a vehicle, and can be appropriately applied to various moving bodies such as a ship and an aircraft.

The display terminal 5 is, for example, AR glasses worn by the user. The display terminal 5 executes an assist information display program to communicate with the information processing device 7 that provides the assist information to be superimposed and displayed on the user's field of view, thereby displaying the assist information in the user's field of view. The display terminal 5 superimposes and displays the assist information regarding the object on the user's field of view at timing corresponding to a position of the object in the user's field of view. More specifically, the display terminal 5 acquires the assist information and information about a superimposition position of the assist information from the information processing device 7, and displays or projects the assist information at a position in the field of view of the object within the user's field of view, that is, at timing corresponding to the superimposition position. In addition, the display terminal 5 acquires position information and line-of-sight information about the user, and outputs the information to the information processing device 7. In addition, the display terminal 5 acquires the position information about the camera terminal 3 and the line-of-sight information about the user, and outputs the information to the information processing device 7.

Note that, in the present embodiment, the AR glasses are described as an example of the display terminal 5, but the present disclosure is not limited thereto. The display terminal 5 is not limited to a glasses-type head mounted display (HMD) such as the AR glasses, and a contact lens type wearable device may be used. The display terminal 5 is not limited to a wearable device such as the HMD, and for example, a head-up display (HUD) mounted on the moving body 2 or the like may be used.

Note that, in the present embodiment, the assist information display system 1 to which the Augmented Reality (AR) technology is mainly applied is described as an example, but the present disclosure is not limited thereto. The assist information display system 1 according to the present embodiment is not limited to AR, and various XR technologies such as Virtual Reality (VR), Mixed Reality (MR), and Substitutional Reality (SR) can be applied. Therefore, in the present embodiment, superimposing and displaying the assist information on the user's field of view includes not only displaying or projecting the assist information in the user's field of view but also superimposing and displaying the assist information on an image corresponding to the user's field of view. For example, in a case where a line-of-sight direction of the user is regarded as the traveling direction of the moving body 2, the image obtained by the camera terminal 3 is an image representing the user's field of view. Therefore, in the assist information display system 1 to which the VR technology is applied, the assist information may be superimposed on the image obtained by the camera terminal 3. Alternatively, the camera terminal 3 may be configured to be able to acquire an image in an imaging direction corresponding to the line-of-sight information about the user acquired by the display terminal 5.

The information processing device 7 is an example of a device that implements an assist information providing method according to the embodiment, and is a device that communicates with the display terminal 5 that displays video in the user's field of view and provides the display terminal 5 with the assist information displayed on the display terminal 5. The information processing device 7 acquires an image obtained by imaging a moving direction of the user from the camera terminal 3, and detects an object included in the image. The information processing device 7 determines a position of the detected object in the user's field of view, and determines the determined position as a superimposition position of the assist information regarding the object. Moreover, the information processing device 7 determines timing at which the assist information regarding the object is superimposed and displayed on the user's field of view in accordance with the position of the object in the user's field of view. The information processing device 7 outputs (or transmits), to the display terminal 5, information about the assist information, the superimposition position, and the superimposition timing.

The management device 8 includes a database that stores user information and map information, and manages the user information and the map information. The user information includes an ID for identifying the user and characteristic information about the user. The characteristic information about the user is information indicating a characteristic of a reaction in the user's field of view, for example, distraction to the right.

Although FIG. 1 illustrates the assist information display system 1 including one camera terminal 3 and one display terminal 5 as an example, the present disclosure is not limited thereto. In the assist information display system 1, two or more camera terminals 3 and two or more display terminals 5 may be included.

FIG. 2 is a block diagram illustrating an example of a hardware configuration of each device included in the assist information display system 1 according to the embodiment.

Note that each device included in the assist information display system 1 may be configured by a combination of multiple devices. While FIG. 2 illustrates a case where each device included in the assist information display system 1 according to the embodiment is configured by a single piece of hardware as an example, the present disclosure is not limited thereto. As an example, processing executed by the information processing device 7 in assist information display processing according to the embodiment may be implemented by distributed processing by multiple devices.

The camera terminal 3, the display terminal 5, the information processing device 7, and the management device 8 each include, for example, a processor 11, a memory 12, and a communication circuit 13. The processor 11, the memory 12, and the communication circuit 13 are communicably connected to each other via a bus 19.

The processor 11 controls the overall operation of each device (the camera terminal 3, the display terminal 5, the information processing device 7, and the management device 8) of the assist information display system 1. The processor 11 implements each function of each device by executing a program loaded in a RAM of the memory 12.

As the processor 11, various processors such as a central processing unit (CPU), a graphics processing unit (GPU), an application specific integrated circuit (ASIC), and a field programmable gate array (FPGA) can be used as appropriate.

The memory 12 stores various data and programs used in each device of the assist information display system 1. As the memory 12, various storage media (recording media) and storage devices such as a read only memory (ROM), a hard disk drive (HDD), a solid state drive (SSD), and a flash memory can be used as appropriate. The memory 12 is further provided with a random access memory (RAM) that temporarily stores working data.

The communication circuit 13 is a circuit for communicating with the outside via a network. As the communication circuit 13, a communication circuit for wired communication, a communication circuit for wireless communication, and a combination thereof can be appropriately used. As the communication circuit for wireless communication, communication circuits corresponding to various standards such as next-generation communication standards including 3G, 4G, 5G, 6G, and satellite communication, Wi-Fi (registered trademark), and Bluetooth (registered trademark) can be appropriately used.

The display terminal 5 further includes, for example, a display device 14. The display device 14 is connected to the processor 11 and the like via the bus 19. In one example, the display device 14 is a device that projects an image onto the retina. The display device 14 includes a projection unit that emits laser light for representing an image, and an optical system including a mirror that forms an image of the laser light from the projection unit on the retina. Alternatively, the display device 14 includes, for example, an optical system including a half mirror and a projection unit that projects an image onto the half mirror. The display device 14 presents the assist information to the user.

Note that the information processing device 7 and the management device 8 may each include the display device 14 such as a liquid crystal display, an organic EL display, or a projector. Moreover, the camera terminal 3, the display terminal 5, the information processing device 7, and the management device 8 may each include an input device that receives an operation input of the user, such as a keyboard, a microphone that receives a voice input of the user, a speaker that presents a voice corresponding to voice data to the user, and the like.

The camera terminal 3 and the display terminal 5 each include a camera 15. The camera 15 of the camera terminal 3 is configured to be able to perform imaging in the traveling direction of the moving body 2. The camera 15 of the display terminal 5 is configured to be able to image the eyeball(s) of the user who wears the display terminal 5. In other words, the camera 15 of the display terminal 5 captures an image including the eyeball of the user wearing the display terminal 5.

The display terminal 5 further includes a sensor 16. In one example, the sensor 16 is a position sensor such as a GPS sensor that acquires position information about the display terminal 5. The position sensor may be configured as a sensor that acquires position information using an access point such as Wi-Fi, a Bluetooth Low Energy beacon, or the like. Note that a direction sensor such as a gyro sensor that acquires a direction of the display terminal 5 may be further provided as the sensor 16.

Note that, in the assist information display system 1, the information processing device 7 may be configured to be able to access a database that stores user information and map information via a computer-readable recording medium or a portable external storage device. As the computer-readable recording medium, for example, a CD-ROM, a flexible disk (FD), a CD-R, a digital versatile disk (DVD), or the like can be appropriately used. In addition, as the portable external storage device, an HDD, an SSD, a flash memory, or the like can be appropriately used.

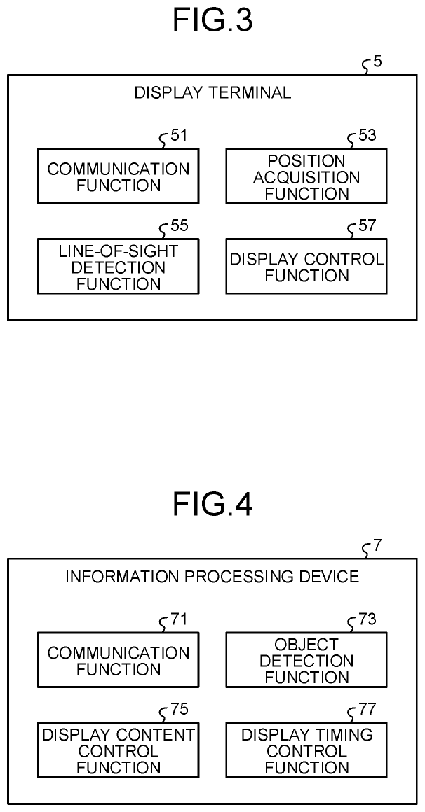

FIG. 3 is a block diagram illustrating an example of a functional configuration of the display terminal 5 according to the first embodiment. In the display terminal 5, the processor 11 executes a program loaded in the RAM of the memory 12 to implement functions as a communication function 51, a position acquisition function 53, a line-of-sight detection function 55, and a display control function 57. Here, the program for implementing the functions as the communication function 51, the position acquisition function 53, the line-of-sight detection function 55, and the display control function 57 is an example of the assist information display program.

In the communication function 51, the processor 11 of the display terminal 5 outputs the position information about the display terminal 5 acquired by the position acquisition function 53 and the line-of-sight information about the user acquired by the line-of-sight detection function 55 to the information processing device 7 by the communication circuit 13. In addition, the processor 11 acquires information indicating the assist information, the superimposition position, and the superimposition timing from the information processing device 7 by the communication circuit 13.

In the position acquisition function 53, the processor 11 of the display terminal 5 acquires position information indicating the position of the display terminal 5, that is, the position of the user by the sensor 16.

In the line-of-sight detection function 55, the processor 11 of the display terminal 5 acquires, for example, line-of-sight information indicating a line-of-sight direction of the user on the basis of the image including the eyeball of the user acquired by the camera 15. The line-of-sight direction of the user can be detected by, for example, extracting a region of the eyeball from the image and using a direction of the extracted region of the eyeball. Alternatively, in a case where the sensor 16 is configured to be able to detect the direction of the display terminal 5, the processor 11 may acquire the direction of the display terminal 5 detected by the sensor 16 as the line-of-sight direction of the user. Alternatively, the processor 11 may acquire the imaging direction of the camera terminal 3, that is, the moving direction of the user by the moving body 2 as the line-of-sight direction of the user.

In the display control function 57, the processor 11 of the display terminal 5 superimposes and displays the assist information regarding the object located in the moving direction of the user on the user's field of view by the display device 14. The processor 11 displays the assist information regarding the object at the position of the object in the user's field of view. The processor 11 displays the assist information regarding the object at timing corresponding to the display position of the assist information.

FIG. 4 is a block diagram illustrating an example of a functional configuration of the information processing device 7 according to the first embodiment. In the information processing device 7, the processor 11 functions as a communication function 71, an object detection function 73, a display content control function 75, and a display timing control function 77.

In the communication function 71, the processor 11 of the information processing device 7 acquires an image obtained by imaging the moving direction of the user from the camera terminal 3 by the communication circuit 13. The processor 11 acquires the position information and the line-of-sight information about the user from the display terminal 5 by the communication circuit 13. The processor 11 acquires the user information and the map information from the management device 8 by the communication circuit 13. The processor 11 outputs (or transmits) information indicating the assist information, the superimposition position, and the superimposition timing to the display terminal 5 by the communication circuit 13.

In the object detection function 73, the processor 11 of the information processing device 7 detects the object included in the image obtained by imaging the moving direction of the user. The object to be detected includes other moving bodies such as other pedestrians and vehicles, structures, signs, and marks.

In the display content control function 75, the processor 11 of the information processing device 7 selects the assist information in accordance with the detected object. In one example, when the object is a moving body such as a pedestrian or a bicycle, an icon indicating the object is selected as the assist information to be superimposed and displayed. Moreover, in a case where it is difficult to see the display due to a forward vehicle, a structure, or the like, the processor 11 may change the display position of the assist information to a position avoiding the forward vehicle, the structure, or the like.

In the display content control function 75, the processor 11 of the information processing device 7 determines the position of the object detected from the image obtained by imaging the moving direction of the user in the user's field of view. Specifically, the processor 11 determines the position of the object in the user's field of view on the basis of the position information, the line-of-sight information, and the map information about the user. The processor 11 determines the determined position of the object in the user's field of view as the superimposition position of the assist information. Note that, for example, in a case where the user is on the moving body 2, the processor 11 may determine the position of the object in the user's field of view by acquiring the position information about the moving body 2 as the position information about the user. Moreover, for example, in a case where a camera that captures an image of the head of the user is mounted on the moving body 2, the processor 11 may determine the position of the object in the user's field of view by acquiring the line-of-sight information about the user on the basis of the captured image of the camera.

In the display timing control function 77, the processor 11 of the information processing device 7 determines the superimposition timing of the assist information in accordance with the position of the object detected from the image obtained by imaging the moving direction of the user in the user's field of view, namely, the superimposition position of the assist information.

As an example, in the display timing control function 77, when the superimposition position of the assist information is within a user's peripheral field of view, the processor 11 of the information processing device 7 determines the superimposition timing earlier than that when the superimposition position is within a user's effective field of view. Here, the user's field of view is a region including the user's peripheral field of view and the user's effective field of view. The user's effective field of view is a visual field region defined from the viewpoint of whether or not a person can recognize the presence of the object in the user's field of view, and is an example of a second visual field region. The user's peripheral field of view is a visual field region that is located at an outer peripheral portion of the effective field of view and is defined from the viewpoint of whether or not a person can recognize the presence of a light spot, and is an example of a first visual field region.

As another example, in the display timing control function 77, the processor 11 of the information processing device 7 determines the superimposition timing at earlier timing as the superimposition position of the assist information deviates from the center of the user's field of view. Here, the center of the user's field of view is, for example, a central field of view in the user's field of view. The central field of view is a visual field region defined by a range in which visual cells having high sensitivity to light at the center of the human retina are concentrated.

Note that, in the display timing control function 77, the processor 11 of the information processing device 7 may determine the superimposition timing in accordance with the characteristic information about the user included in the user information, in addition to the superimposition position. For example, when the characteristic information about the user is information indicating distraction to the right, the processor 11 determines superimposition timing earlier than the superimposition timing regarding the superimposition position on the left with respect to the superimposition position on the right in the user's field of view.

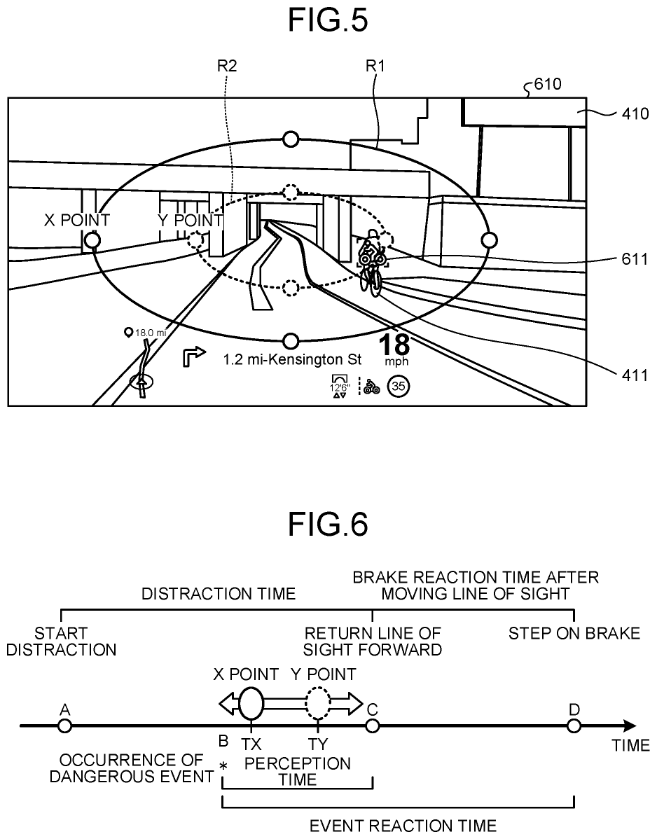

FIG. 5 is a diagram illustrating a relation between a user's field of view and a superimposition position in the superimposition display of the assist information according to the first embodiment. FIG. 5 illustrates a case where a bicycle 411 is detected from an image 410 obtained by imaging the moving direction of the user. As illustrated in FIG. 5, the display content control function 75 selects an icon 611 as the assist information to be superimposed and displayed on a user's field of view 610 in response to the detected object being the bicycle 411. The display content control function 75 determines a position of the bicycle 411 in the user's field of view 610 as a superimposition position where the icon 611 is superimposed and displayed. The display timing control function 77 determines superimposition timing of the icon 611 at timing later than that of an object in a first visual field region R1 corresponding to a user's peripheral field of view because the superimposition position is in a second visual field region R2 corresponding to a user's effective field of view.

FIG. 6 is a diagram illustrating a relation between a superimposition position and display timing in the superimposition display of the assist information according to the first embodiment. FIG. 6 illustrates an X point in the first visual field region and a Y point in the second visual field region as an example. Here, a case where the user starts distraction at a time point A, a dangerous event occurs at a time point B, and the user returns a line of sight forward at a time point C will be described as an example. In addition, it is assumed that the assist information is superimposed and displayed at a position of an object of the dangerous event in the user's field of view.

In this case, since the object of the dangerous event is located outside the user's field of view or in the user's peripheral field of view from the time point B at which the dangerous event occurs to the time point C at which the user returns the line of sight forward, the user cannot recognize the occurrence of the dangerous event. That is, at the time point C at which the user returns the line of sight forward and the object of the dangerous event is located within the user's effective field of view, the user recognizes the dangerous event. However, a delay occurs by a reaction time of the user from when the user recognizes the dangerous event at the time point C to when the user takes a measure such as stepping on a brake at a time point D. Therefore, in order to shorten the event reaction time from the time point B at which the dangerous event occurs to the time point D at which the user takes a measure, it is required to shorten the time from when the dangerous event occurs at the time point B to when the user recognizes the occurrence of the dangerous event.

Therefore, the assist information display system 1 according to the present embodiment is configured to superimpose and display the assist information at timing (time point TX) earlier than superimposition timing (time point TY) when the superimposition position of the assist information is the Y point in the user's effective field of view, when the superimposition position of the assist information is the X point in the user's peripheral field of view.

Hereinafter, an operation of the assist information display system 1 according to the embodiment will be described with reference to the drawings. Note that the procedure of processing described below is an example, and it is also possible to change the processing order, delete some processing, and add other processing.

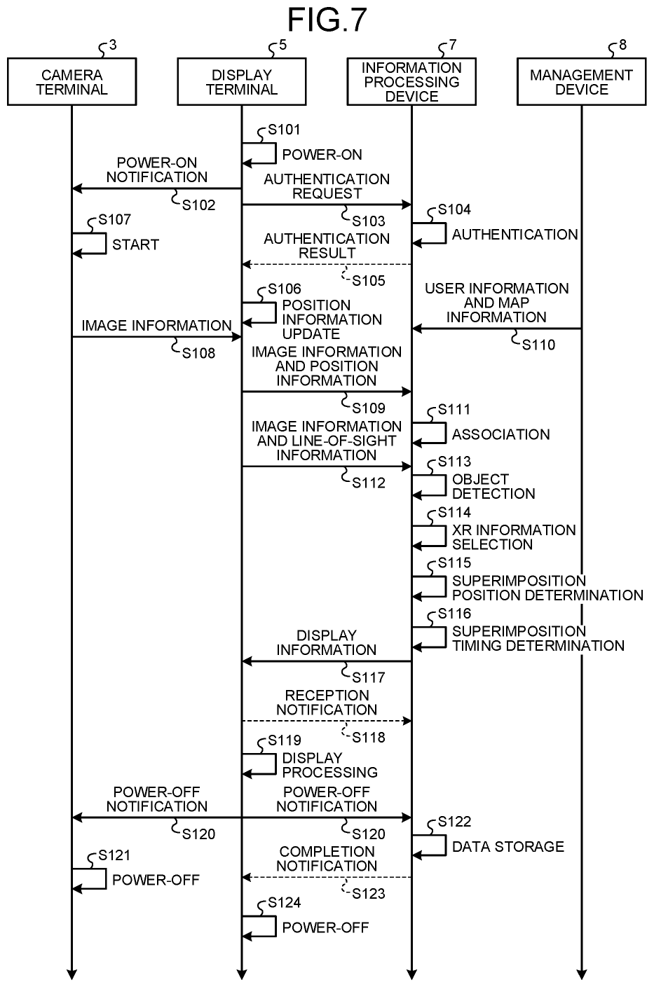

FIG. 7 is a sequence diagram illustrating an example of assist information display processing according to the first embodiment.

After power-on (S101), the display terminal 5 transmits a power-on notification to the camera terminal 3 (S102), and transmits an authentication request to the information processing device 7 (S103).

The information processing device 7 performs authentication processing in response to the authentication request from the display terminal 5 (S104), and returns an authentication result to the display terminal 5 (S105).

After the authentication is completed, the display terminal 5 updates the position information (S106). The camera terminal 3 receives the power-on notification from the display terminal 5 and starts (S107), and starts acquisition of an image obtained by imaging the moving direction of the user. The camera terminal 3 transmits data of the acquired image, that is, image information to the display terminal 5 as needed (S108). The display terminal 5 transmits the acquired position information and image information to the information processing device 7 (S109).

The information processing device 7 acquires user information and map information about the user identified by the authentication from the management device 8 (S110). In addition, the information processing device 7 associates the position information and the image information received from the display terminal 5 with the user information and the map information acquired from the management device 8 (S111).

The display terminal 5 acquires the line-of-sight information about the user, and transmits the newly acquired image information and line-of-sight information to the information processing device 7 (S112). The information processing device 7 detects the object in the image on the basis of the image information from the display terminal 5 (S113). The information processing device 7 selects the assist information, which is XR information to be superimposed and displayed on the user's field of view, according to the detected object (S114). The information processing device 7 determines the position of the object in the user's field of view on the basis of the position information, the line-of-sight information, and the map information about the user, and decides that the determined position is the superimposition position of the assist information (S115). The information processing device 7 determines superimposition timing of the assist information in accordance with the superimposition position of the assist information (S116). The information processing device 7 transmits display information indicating the assist information, the superimposition position, and the superimposition timing to the display terminal 5 (S117).

The display terminal 5 receives the display information from the information processing device 7, and returns a reception notification to information processing device 7 (S118). Then, the display terminal 5 executes display processing of displaying the assist information regarding the object located in the moving direction of the user at a superimposition position that is a position of the object in the user's field of view at timing corresponding to the superimposition position (S119).

Thereafter, for example, in response to the user operation or the end of the movement, the display terminal 5 transmits a power-off notification to the camera terminal 3 and the information processing device 7 (S120). The camera terminal 3 is turned off in response to the power-off notification from the display terminal 5 (S121). In addition, the information processing device 7 stores processing data in response to the power-off notification from the display terminal 5 (S122), and returns a completion notification to the display terminal 5 (S123). The display terminal 5 receives the completion notification from the information processing device 7 and is turned off (S124).

As described above, the assist information display system 1 according to the embodiment is configured to determine the superimposition display timing in accordance with the superimposition position of the assist information, when the assist information regarding the object in the moving direction of the user is superimposed and displayed on the user's field of view. That is, the assist information display system 1 according to the embodiment is configured to superimpose and display the assist information on the user's field of view at the timing corresponding to the user's visual characteristics. With this configuration, it is possible to suppress the recognition variation due to the display position, so that it is possible to enhance the visibility of the assist information superimposed and displayed on the user's field of view. Since the visibility of the assist information is enhanced and action assist and driving assist such as appropriate attention calling and information provision to the user are implemented, it is possible to enhance convenience for the user such as suppressing occurrence of an accident.

### Second Embodiment

In the above-described first embodiment, the assist information display system 1 that is constructed as a server-client type system has been described, but the present disclosure is not limited thereto. In the second embodiment, a case where the whole of the assist information display processing according to the embodiment is executed in a display terminal 5 will be described as an example.

An assist information display system 1 according to the present embodiment includes a camera terminal 3 mounted on a moving body 2 and a display terminal 5. The camera terminal 3 and the display terminal 5 can communicate directly or via a network 9.

In the assist information display system 1 according to the present embodiment, the display terminal 5 is configured to be able to partially execute functions of an information processing device 7 and a management device 8 according to the first embodiment. Specifically, the display terminal 5 according to the present embodiment has functions as an object detection function 73, a display content control function 75, and a display timing control function 77, similarly to the information processing device 7 according to the first embodiment. Similarly to the management device 8 according to the first embodiment, the display terminal 5 stores user information and map information.

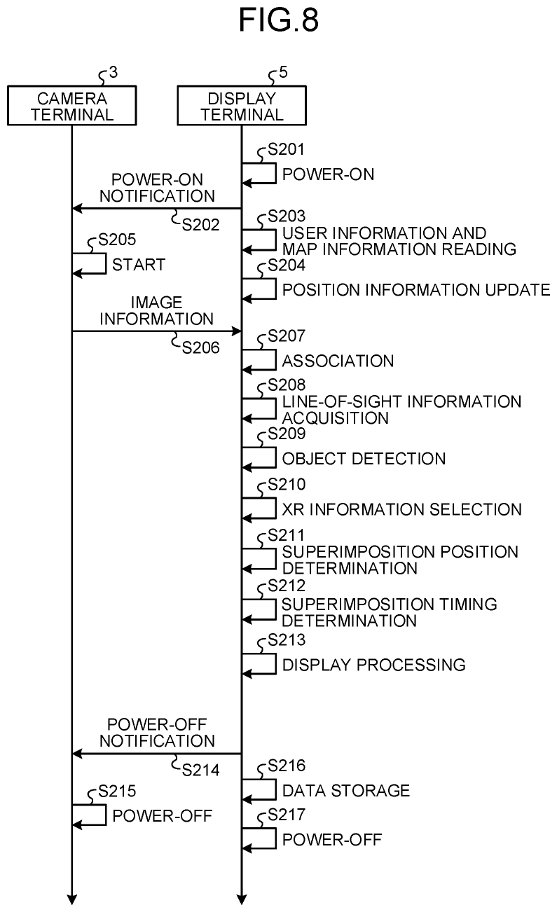

FIG. 8 is a sequence diagram illustrating an example of assist information display processing according to the second embodiment. Here, differences from the assist information display processing according to the first embodiment of FIG. 7 will be mainly described.

After power-on (S201), the display terminal 5 transmits a power-on notification to the camera terminal 3 (S202), and reads user information and map information, similarly to the processing of S110 (S203). The display terminal 5 updates position information, similarly to the processing of S106 (S204). In addition, the camera terminal 3 receives the power-on notification from the display terminal 5 and starts (S205), and transmits data of an image obtained by imaging a moving direction of a user, that is, image information to the display terminal 5 as needed (S206).

Similarly to the processing of S111 to S119, after associating the position information, the image information, the user information, and the map information (S207), the display terminal 5 acquires line-of-sight information about the user (S208), detects an object in the image on the basis of the image information (S209), and selects assist information in accordance with the detected object (S210). Then, the display terminal 5 determines a superimposition position of the assist information (S211), determines superimposition timing corresponding to the superimposition position (S212), and executes display processing of the assist information (S213).

Thereafter, the camera terminal 3 is turned off in response to the power-off notification (S214) from the display terminal 5 (S215). In addition, the display terminal 5 stores processing data (S216) and is then turned off (S217), similarly to the processing of S122.

Even with this configuration, effects similar to those of the first embodiment can be obtained. In addition, the assist information display system 1 according to the present embodiment can reduce an influence of communication delay and communication failure as compared with the assist information display system 1 according to the first embodiment.

Note that, in the second embodiment, the case where the entire assist information display processing is executed by the display terminal 5 has been described as an example. However, for example, there may be a mode in which only processing with a high calculation load such as object detection is executed at the outside of the display terminal 5 such as the information processing device 7. In addition, there may be a mode in which, after superimposition content including the superimposition position is determined outside the display terminal 5, the superimposition timing is determined according with the superimposition position and/or the line-of-sight information in the display terminal 5.

The computer program executed by each device of the assist information display system 1 according to each of the above-described embodiments is provided by being recorded in a computer-readable recording medium such as a CD-ROM, an FD, a CD-R, or a DVD as a file in an installable format or an executable format.

In addition, the program executed by each device of the assist information display system 1 according to each of the above-described embodiments may be stored on a computer connected to a network such as the Internet and provided by being downloaded via the network. In addition, the program executed by each device of the assist information display system 1 according to each of the above-described embodiments may be provided or distributed via the network such as the Internet.

In addition, the program executed by each device of the assist information display system 1 according to each of the above-described embodiments may be provided by being incorporated in advance in a ROM or the like.

According to at least one embodiment described above, it is possible to enhance the visibility of the assist information superimposed and displayed on the user's field of view.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Supplementary Notes

The following technologies are disclosed by the above description of the embodiments.

(Supplementary note 1)

An assist information providing method in an information processing device, the information processing device communicating with a display terminal displaying an image on a user's field of view to provide assist information to be displayed on the display terminal, the method comprising:
acquiring an image obtained by performing imaging in a moving direction of a user;
detecting an object included in the image;
determining a position of the object in the user's field of view as a superimposition position of assist information regarding the object; and
transmitting information about the superimposition position to the display terminal to cause the display terminal to superimpose and display the assist information on the user's field of view at timing corresponding to the superimposition position.
   (Supplementary note 2)

The assist information providing method according to the supplementary note 1, wherein, when the superimposition position is located in a first visual field region being an outer peripheral portion of the user's field of view, the assist information is superimposed and displayed on the user's field of view at timing earlier than timing when the superimposition position is a second visual field region being a central part of the user's field of view.

(Supplementary note 3)

The assist information providing method according to the supplementary note 1, wherein the assist information is superimposed and displayed on the user's field of view at earlier timing as the superimposition position deviates from the center of the user's field of view.

(Supplementary note 4)

The assist information providing method according to the supplementary note 1, further comprising:
acquiring a line-of-sight direction of the user and position information about the user; and
determining a position of the object in the user's field of view on the basis of the line-of-sight direction, the position information, and map information.
   (Supplementary note 5)

The assist information providing method according to any one of the supplementary notes 1 to 4, wherein the assist information is superimposed and displayed on the user's field of view at timing corresponding to characteristic information about the user.

(Supplementary note 6)

The assist information providing method according to any one of the supplementary notes 1 to 5, further comprising selecting the assist information to be displayed in accordance with the detected object.

(Supplementary note 7)

The assist information providing method according to any one of the supplementary notes 1 to 6, further comprising:
determining timing at which the assist information is displayed in the user's field of view, the timing corresponding to the superimposition position; and
transmitting, to the display terminal, information about the timing corresponding to the superimposition position together with the information about the superimposition position.
   (Supplementary note 8)

A computer program causing a computer to execute processing, the computer being included in a display terminal communicating with an information processing device providing assist information, the display terminal superimposing and displaying the assist information on a user's field of view, the processing to be executed by the computer comprising:
acquiring, from the information processing device, a superimposition position of assist information regarding an object located in a moving direction of the user, the superimposition position being determined as a position of the object in the user's field of view; and
superimposing and displaying the assist information on the user's field of view at timing corresponding to the superimposition position.
   (Supplementary note 9)

A non-transitory computer-readable recording medium on which the computer program according to the supplementary note 8 is recorded.

What is claimed is:

1. An assist information providing method in an information processing device, the information processing device communicating with a display terminal displaying an image on a user's field of view to provide assist information to be displayed on the display terminal, the method comprising:
acquiring an image obtained by performing imaging in a moving direction of a user;
detecting an object included in the image;
determining a position of the object in the user's field of view as a superimposition position of assist information regarding the object; and
transmitting information about the superimposition position to the display terminal to cause the display terminal to superimpose and display the assist information on the user's field of view at timing corresponding to the superimposition position.

2. The assist information providing method according to claim 1, wherein, when the superimposition position is located in a first visual field region being an outer peripheral portion of the user's field of view, the assist information is superimposed and displayed on the user's field of view at timing earlier than timing when the superimposition position is a second visual field region being a central part of the user's field of view.

3. The assist information providing method according to claim 1, wherein the assist information is superimposed and displayed on the user's field of view at earlier timing as the superimposition position deviates from the center of the user's field of view.

4. The assist information providing method according to claim 1, further comprising:
acquiring a line-of-sight direction of the user and position information about the user; and
determining a position of the object in the user's field of view on the basis of the line-of-sight direction, the position information, and map information.

5. The assist information providing method according to claim 1, wherein the assist information is superimposed and displayed on the user's field of view at timing corresponding to characteristic information about the user.

6. The assist information providing method according to claim 1, further comprising selecting the assist information to be displayed in accordance with the detected object.

7. The assist information providing method according to claim 1, further comprising:
determining timing at which the assist information is displayed in the user's field of view, the timing corresponding to the superimposition position; and
transmitting, to the display terminal, information about the timing corresponding to the superimposition position together with the information about the superimposition position.

8. A non-transitory computer-readable recording medium on which programmed instructions are recorded, the instructions causing a computer to execute processing, the computer being included in a display terminal communicating with an information processing device providing assist information, the display terminal superimposing and displaying the assist information on a user's field of view, the processing to be executed by the computer comprising:
acquiring, from the information processing device, a superimposition position of assist information regarding an object located in a moving direction of the user, the superimposition position being determined as a position of the object in the user's field of view; and
superimposing and displaying the assist information on the user's field of view at timing corresponding to the superimposition position.
